(19) United States
(12) Patent Application Publication
(10) Pub. No.: US 2022/0030922 A1
(43) Pub. Date: Feb. 3, 2022

(54) Breakdown Product of Thallus of Plant of Subfamily Lemnoideae

(71) Applicant: AJINOMOTO CO., INC., Tokyo (JP)

(72) Inventor: Souichirou Hata, Kanagawa (JP)

(73) Assignee: AJINOMOTO CO., INC., Tokyo (JP)

(21) Appl. No.: 17/505,173

(22) Filed: Oct. 19, 2021

Related U.S. Application Data
(63) Continuation of application No. PCT/JP2020/014446, filed on Mar. 30, 2020.

(30) Foreign Application Priority Data
Apr. 22, 2019 (JP) 2019-080898

(51) Int. Cl. A23L 11/30; A23L 27/30

(52) U.S. Cl. CPC A23L 11/34; A23L 27/30

(57) ABSTRACT

Provided herein is composition containing a destroyed frond of a Lemnoideae plant with a suppressed off-flavor, and a method for suppressing an off-flavor of a destroyed frond of a Lemnoideae plant. A composition containing a destroyed frond of a Lemnoideae plant and also containing an organic acid salt, an inorganic salt, a sweetener, and/or an acidulant; and a method for suppressing an off-flavor, including blending an organic acid salt, an inorganic salt, a sweetener, and/or an acidulant with a destroyed frond of a Lemnoideae plant, are provided herein.

This application is a Continuation of, and claims priority under 35 U.S.C. § 120 to, International Application No. PCT/JP2020/014446, filed Mar. 30, 2020, and claims priority therethrough under 35 U.S.C. § 119 to Japanese Patent Application No. 2019-080898, filed Apr. 22, 2019, the entireties of which are incorporated by reference herein.

### BACKGROUND

### Technical Field

The present invention relates to a destroyed frond of a Lemnoideae plant with a suppressed off-flavor, and a method for suppressing an off-flavor of a destroyed frond of a Lemnoideae plant.

### Background Art

Wolffia globosa, which is one type of Lemnoideae plant, is high in protein, has good amino acid balance, is absorbed well, and is allergen-free. Therefore, its use as a food product that can be easily taken to supplement nutrition in good balance has been reported.

However, Wolffia globosa has a problem that when the frond is destroyed for use as a food, a peculiar off-flavor, particularly a sea smell also called algae smell, develops and the flavor becomes poor.

Patent document 1 discloses the use of a plant of the Wolffia genus as a coloring agent, and patent document 2 discloses a dough containing a plant of Wolffia genus. However, a method for suppressing an off-flavor of a destroyed frond of the Lemnoideae plant (e.g., Wolffia globosa) has not been studied.

### PATENT DOCUMENTS

Patent document 1: Japanese Translation of PCT Application Publication No. 2015-523096
Patent document 2: Japanese Translation of PCT Application Publication No. 2017-504338

### SUMMARY

It is one aspect of the present invention to provide a destroyed frond of the Lemnoideae plant with a suppressed off-flavor, particularly a sea smell, and a method for suppressing an off-flavor, particularly a sea smell of a destroyed frond of the Lemnoideae plant.

Described herein is a method for suppressing the peculiar off-flavor, particularly a sea smell, and improving the desired flavor by blending a destroyed frond of a Lemnoideae plant with an organic acid salt, an inorganic salt, a sweetener, and/or an acidulant.

It is an aspect of the present invention to provide a composition comprising a destroyed frond of a Lemnoideae plant and an additive selected from the group consisting of an organic acid salt, an inorganic salt, a sweetener, an acidulant, and combinations thereof.

It is a further aspect of the present invention to provide the composition as described above, wherein the additive comprises an organic acid salt or an inorganic salt.

It is a further aspect of the present invention to provide a method for suppressing an off-flavor, comprising blending an additive selected from the group consisting of an organic acid salt, an inorganic salt, a sweetener, an acidulant, and combinations thereof with a destroyed frond of a Lemnoideae plant.

It is a further aspect to provide the method as described above, wherein said additive comprises an organic acid salt or an inorganic salt.

### DETAILED DESCRIPTION

An off-flavor, particularly a sea smell, of a destroyed frond of a Lemnoideae plant such as Wolffia globosa and the like can be suppressed by blending with an organic acid salt, an inorganic salt, a sweetener and/or an acidulant.

The destroyed frond of a Lemnoideae plant can be blended with an organic acid salt, an inorganic salt, a sweetener, and/or an acidulant.

Examples of the Lemnoideae plant include Wolffia globosa, Wolffia angusta, Wolffia arrhiza, Wolffia australiana, Wolffia borealis, Wolffia brasiliensis, Wolffia columbiana, Wolffia cylindracea, Wolffia elongata, Wolffia microscopica, and Wolffia neglecta.

The “destroyed frond of a Lemnoideae plant” is obtained by applying a force such as compression, impact, shear, friction, and the like. The degree of destruction is not limited, and the frond may be only partially destroyed.

The destroyed frond of a Lemnoideae plant as a starting material can be produced by, for example, destroying the frond of a Lemnoideae plant with a squeezing machine, a shearing machine, or the like.

The destroyed frond of a Lemnoideae plant as a starting material may be a dried product, and a commercially available dry powder of the destroyed frond of a Lemnoideae plant (e.g., “Mankai” D110 (trade name), Hinoman Ltd.) may be used.

The destroyed frond of a Lemnoideae plant as a starting material, that is, the destroyed frond of a Lemnoideae plant before blending with organic acid salt, inorganic salt, sweetener and/or acidulant, is indicated as “a destroyed frond of a Lemnoideae plant (starting material)”.

Examples of the organic acid salt include alkali metal salts, e.g., sodium salt, potassium salt, and alkaline earth metal salts, e.g., calcium salt with organic acids such as citric acid, gluconic acid, lactic acid, malic acid, and the like.

The organic acid salt can be, specifically, for example, citrate, e.g., sodium citrate, e.g., trisodium citrate, potassium citrate, calcium citrate; gluconate, e.g., calcium gluconate, sodium gluconate, potassium gluconate; lactate, e.g., fermented calcium lactate, calcium lactate, sodium lactate; or malate, e.g., sodium malate.

To suppress the off-flavor, the amount of the organic acid salt is, for example, not less than 0.0025 parts by weight, not less than 0.005 parts by weight, or not less than 0.01 part by weight, per 1 part by weight in dry weight of the destroyed frond of a Lemnoideae plant (starting material). The amount of the organic acid salt can be, for example, not more than 1 part by weight per 1 part by weight (in dry weight) of the destroyed frond of a Lemnoideae plant (starting material).

The off-flavor can be suppressed by adjusting the amount of the organic acid salt to fall within the following ranges, without impairing the desired flavor of the material of the destroyed frond of a Lemnoideae plant.

To suppress the off-flavor and maintain the desired flavor, the amount of the organic acid salt can be, for example, 0.0025-0.03 parts by weight, or 0.005-0.02 parts by weight, per 1 part by weight in dry weight of the destroyed frond of a Lemnoideae plant (starting material).

Examples of the inorganic salt include sodium chloride, e.g., dietary sodium chloride, potassium chloride, calcium chloride, magnesium chloride, and carbonate, e.g., sodium carbonate, potassium carbonate, calcium carbonate.

To suppress the off-flavor, the amount of the inorganic salt can be, for example, not less than 0.0025 parts by weight, not less than 0.005 parts by weight, or not less than 0.01 part by weight, per 1 part by weight (in dry weight) of the destroyed frond of a Lemnoideae plant (starting material). The amount of the inorganic salt is, for example, not more than 1 part by weight, per 1 part by weight (in dry weight) of the destroyed frond of a Lemnoideae plant (starting material).

The off-flavor can be suppressed without impairing the desired flavor of the material of the destroyed frond of a Lemnoideae plant by adjusting the amount of the inorganic salt to fall within the following ranges.

To suppress the off-flavor and maintain the desired flavor, the amount of the inorganic salt can be, for example, 0.0025-0.02 parts by weight, or 0.005-0.01 parts by weight, per 1 part by weight (in dry weight) of the destroyed frond of a Lemnoideae plant (starting material).

A carbohydrate sweetener and/or a sweetener other than a carbohydrate can be used as the sweetener.

Examples of the carbohydrate sweetener include monosaccharides, disaccharides, tetrasaccharides, oligo saccharides, sugar alcohols, maltodextrin, dextrin, and starch. The disaccharide is not particularly limited and sucrose, lactose, maltose, trehalose, palatinose, lactulose, and cellobiose can be mentioned. Examples of sucrose include granulated sugar, powder sugar, and the like.

Examples of the sweetener other than a carbohydrate include aspartame, acesulfame K, stevia, sucralose, neotame, advantame, thaumatin, monatin, monellin, and saccharin.

To suppress the off-flavor, the amount of the non-carbohydrate sweetener can be, for example, not less than 0.00025 parts by weight, not less than 0.0005 parts by weight, not less than 0.00075 parts by weight, or not less than 0.00125 part by weight, per 1 part by weight (in dry weight) of the destroyed frond of a Lemnoideae plant (starting material). The amount of the non-carbohydrate sweetener is, for example, not more than 0.01 part by weight per 1 part by weight (in dry weight) of the destroyed frond of a Lemnoideae plant (starting material).

To suppress the off-flavor, the amount of the carbohydrate sweetener can be, for example, not less than 0.15 parts by weight, or not less than 0.3 parts by weight, per 1 part by weight (in dry weight) of the destroyed frond of a Lemnoideae plant (starting material). The amount of the carbohydrate sweetener can be, for example, not more than 100 parts by weight per 1 part by weight (in dry weight) of the destroyed frond of a Lemnoideae plant (starting material).

The off-flavor can be suppressed by adjusting the amount of the sweetener to fall within the following ranges, without impairing the desired flavor of the material of the destroyed frond of a Lemnoideae plant.

To suppress the off-flavor and maintain the desired flavor, the amount of the sweetener can be, for example, 0.00025-0.02 parts by weight, or 0.0005-0.01 part by weight, per 1 part by weight (in dry weight) of the destroyed frond of a Lemnoideae plant (starting material).

Examples of the acidulant include citric acid, malic acid, ascorbic acid, gluconic acid, succinic acid, tartaric acid, fumaric acid, lactic acid, acetic acid, glutamic acid, aspartic acid, and adipic acid.

To suppress the off-flavor, the amount of the acidulant can be, for example, not less than 0.0025 parts by weight, not less than 0.01 part by weight, or not less than 0.015 parts by weight, per 1 part by weight (in dry weight) of the destroyed frond of a Lemnoideae plant (starting material). The amount of the acidulant can be, for example, not more than 1 part by weight per 1 part by weight (in dry weight) of the destroyed frond of a Lemnoideae plant (starting material).

The off-flavor can be suppressed by adjusting the amount of the acidulant to fall within the following ranges, without impairing the desired flavor of the material of the destroyed frond of a Lemnoideae plant.

To suppress the off-flavor and maintain the desired flavor, the amount of the acidulant can be, for example, 0.0025-0.01 parts by weight, or 0.0025-0.005 parts by weight, per 1 part by weight (in dry weight) of the destroyed frond of a Lemnoideae plant (starting material).

The destroyed frond of a Lemnoideae plant can be produced by mixing a destroyed frond of a Lemnoideae plant (starting material) and an organic acid salt, an inorganic salt, a sweetener, and/or an acidulant. A mixing method generally used in the field of food or pharmaceutical preparation can be used.

The destroyed frond of a Lemnoideae plant may contain a component other than the above-mentioned components, for example, an additive used for general foods, as long as it does not inhibit the effects as described herein.

The destroyed frond of a Lemnoideae plant can be directly ingested, or may be ingested by adding to other food.

The term “food” as used herein broadly encompasses foods that can be taken orally, excluding pharmaceuticals, and includes not only so-called “food” but also a drink, health supplement, food with health claims, e.g., food for specified health uses, foods with functional claims, food with nutrient function claims, supplement, and the like.

The destroyed frond of a Lemnoideae plant can be safely ingested by a human, mammals, e.g., mouse, rat, hamster, rabbit, cat, dog, bovine, sheep, monkey; and birds, e.g., chicken, turkey.

Also described herein is a method for suppressing an off-flavor, by blending one or more of an organic acid salt, an inorganic salt, a sweetener, and an acidulant with a destroyed frond of a Lemnoideae plant.

In the method as described herein, the definition and production method of the “destroyed frond of a Lemnoideae plant”, and the examples and amounts of the “organic acid salt”, “inorganic salt”, “sweetener”, and “acidulant” are the same as the definition and production method of the “destroyed frond of a Lemnoideae plant”, and the examples and amounts of the “organic acid salt”, “inorganic salt”, “sweetener”, and “acidulant” explained in the above-mentioned destroyed frond of a Lemnoideae plant.

An off-flavor, particularly a sea smell, of a destroyed frond of a Lemnoideae plant can be suppressed and the desired flavor can be improved by blending with one or more of an organic acid salt, an inorganic salt, a sweetener, and an acidulant.

### EXAMPLE

The present invention is explained in more detail in the following by referring to Examples, Comparative Example, and Experimental Example, which are not to be construed as limiting.

### Examples 1-28 and Comparative Example 1

A dry powder of destroyed fronds of Wolffia globosa (“Mankai” D110 (trade name), Hinoman Ltd.) (2 g) was mixed with various compounds shown in the following Tables 3-9 in the amounts shown in the Tables to prepare mixed powders of Examples 1-11, containing sweetener, Examples 12-19, containing acidulant, Examples 20-27, containing organic acid salt, and Example 28, containing inorganic salt. A dry powder of only destroyed frond of Wolffia globosa was used as Comparative Example 1 (control).

### Experimental Example 1 Determination of the Effect of Blending of a Sweetener, Organic Acid, Organic Acid Salt, Inorganic Salt with a Destroyed Frond of Wolffia globosa on the Distinct Off-Flavor, or Sea Smell, and Flavor of Material

The mixed powders of Examples 1-28 and the powder of Comparative Example 1 were collected by 0.5 g each and used as the test targets. Changes in the distinct off-flavor and flavor of the materials of the mixed powders of Examples 1-28 relative to Comparative Example 1 (control) were studied. The evaluation was performed by sensory evaluation of one professional panelist. The evaluation criteria are as shown in the following Tables 1-2. The results are shown in the following Tables 3-9.

As shown in Tables 3-9, the sweetener, organic acid, organic acid salt, and inorganic salt have a high masking effect on the distinct off-flavor of the destroyed frond of Wolffia globosa. It was also shown that the organic acid salt and the inorganic salt do not easily change the desired flavor of the material of the destroyed frond of Wolffia globosa.

TABLE 1

| score | 1 | 2 | 3 | 4 | 5 |
|---|---|---|---|---|---|
| sea smell | strongly felt | felt | felt a little | slightly felt | not felt |

TABLE 2

| | | | |
|---|---|---|---|
| flavor of | different | somewhat | no change |
| material | | different | |

TABLE 3

| | Comparative Example 1 | | Example 1 | | Example 2 | | Example 3 | |
|---|---|---|---|---|---|---|---|---|
| | | mixing ratio | | mixing ratio | | mixing ratio | | mixing ratio |
| | amount (g) | (%) | amount (g) | (%) | amount (g) | (%) | amount (g) | (%) |
| dry powder of destroyed | 2 | 100.00 | 2 | 99.98 | 2 | 99.95 | 2 | 99.93 |
| frond of Wolffia globosa | | | | | | | | |
| aspartame | — | — | 0.0005 | 0.02 | 0.001 | 0.05 | 0.0015 | 0.07 |
| acesulfame K | — | — | — | — | — | — | — | — |
| stevia | — | — | — | — | — | — | — | — |
| powder sugar | — | — | — | — | — | — | — | — |

| | | | | |
|---|---|---|---|---|
| sea smell | 1 | 2 | 3 | 4 |
| flavor of material | — | somewhat different | somewhat different | different |

TABLE 4

| | Example 4 | | Example 5 | | Example 6 | | Example 7 | |
|---|---|---|---|---|---|---|---|---|
| | | mixing ratio | | mixing ratio | | mixing ratio | | mixing ratio |
| | amount (g) | (%) | amount (g) | (%) | amount (g) | (%) | amount (g) | (%) |
| dry powder of destroyed | 2 | 99.90 | 2 | 99.88 | 2 | 99.85 | 2 | 99.93 |
| frond of Wolffia globosa | | | | | | | | |
| aspartame | 0.002 | 0.10 | 0.0025 | 0.12 | 0.003 | 0.15 | — | — |
| acesulfame K | — | — | — | — | — | — | 0.0015 | 0.07 |
| stevia | — | — | — | — | — | — | — | — |
| powder sugar | — | — | — | — | — | — | — | — |

| | | | | |
|---|---|---|---|---|
| sea smell | 4 | 5 | 5 | 4 |
| flavor of material | different | different | different | different |

TABLE 5

| | Example 8 | | Example 9 | | Example 10 | | Example 11 | |
|---|---|---|---|---|---|---|---|---|
| | | mixing ratio | | mixing ratio | | mixing ratio | | mixing ratio |
| | amount (g) | (%) | amount (g) | (%) | amount (g) | (%) | amount (g) | (%) |
| dry powder of destroyed | 2 | 99.93 | 2 | 93.02 | 2 | 86.% | 2 | 76.92 |
| frond of Wolffia globosa | | | | | | | | |
| aspartame | — | — | — | — | — | — | — | — |
| acesulfame K | — | — | — | — | — | — | — | — |
| stevia | 0.0015 | 0.07 | — | — | — | — | — | — |
| powder sugar | — | — | 0.15 | 6.98 | 0.3 | 13.04 | 0.6 | 23.08 |

| | | | | |
|---|---|---|---|---|
| sea smell | 5 | 2 | 3 | 4 |
| flavor of material | different | somewhat different | different | different |

TABLE 6

| | Comparative Example 1 | | Example 12 | | Example 13 | | Example 14 | | Example 15 | |
|---|---|---|---|---|---|---|---|---|---|---|
| | | mixing | | mixing | | mixing | | mixing | | mixing |
| | | ratio | amount | ratio | amount | ratio | amount | ratio | amount | ratio |
| | amount (g) | (%) | (g) | (%) | (g) | (%) | (g) | (%) | (g) | (%) |
| dry powder of | 2 | 100.00 | 2 | 99.75 | 2 | 99.50 | 2 | 99.01 | 2 | 98.52 |
| destroyed frond of | | | | | | | | | | |
| Wolffia globosa | | | | | | | | | | |
| citric acid | — | — | 0.005 | 0.25 | 0.01 | 0.50 | 0.02 | 0.99 | 0.03 | 1.48 |
| malic acid | — | — | — | — | — | — | — | — | — | — |
| ascorbic acid | — | — | — | — | — | — | — | — | — | — |

| | | | | | |
|---|---|---|---|---|---|
| sea smell | 1 | 3 | 3 | 4 | 5 |
| flavor of material | — | somewhat different | somewhat different | different | different |

TABLE 7

| | Example 16 | | Example 17 | | Example 18 | | Example 19 | |
|---|---|---|---|---|---|---|---|---|
| | amount | mixing ratio | | mixing ratio | | mixing ratio | | mixing ratio |
| | (g) | (%) | amount (g) | (%) | amount (g) | (%) | amount (g) | (%) |
| dry powder of destroyed | 2 | 98.04 | 2 | 97.09 | 2 | 99.01 | 2 | 99.01 |
| fond of Wolffia globosa | | | | | | | | |
| citric acid | 0.04 | 1.96 | 0.06 | 2.91 | — | — | — | — |
| malic acid | — | — | — | — | 0.02 | 0.99 | — | — |
| ascorbic acid | — | — | — | — | — | — | 0.02 | 0.99 |

| | | | | |
|---|---|---|---|---|
| sea smell | 5 | 5 | 2 | 4 |
| flavor of material | different | different | different | somewhat different |

TABLE 8

| | Comparative Example | | | | | | | | | |
|---|---|---|---|---|---|---|---|---|---|---|
| | 1 | | Example 20 | | Example 21 | | Example 22 | | Example 23 | |
| | | mixing | | mixing | | mixing | | mixing | | mixing |
| | amount | ratio | amount | ratio | amount | ratio | amount | ratio | amount | ratio |
| | (g) | (%) | (g) | (%) | (g) | (%) | (g) | (%) | (g) | (%) |
| dry powder of destroyed | 2 | 100.00 | 2 | 99.75 | 2 | 99.50 | 2 | 99.01 | 2 | 98.52 |
| fond of Wolffia globosa | | | | | | | | | | |
| trisodium citrate | — | — | 0.005 | 0.25 | 0.01 | 0.50 | 0.02 | 0.99 | 0.03 | 1.48 |
| calcium gluconate | — | — | — | — | — | — | — | — | — | — |
| fermented calcium lactate | — | — | — | — | — | — | — | — | — | — |
| dietary sodium chloride | — | — | — | — | — | — | — | — | — | — |

| | | | | | |
|---|---|---|---|---|---|
| sea smell | 1 | 3 | 4 | 5 | 5 |
| flavor of material | — | no change | no change | no change | no change |

TABLE 9

| | Example 24 | | Example 25 | | Example 26 | | Example 27 | | Example 28 | |
|---|---|---|---|---|---|---|---|---|---|---|
| | | mixing | | mixing | | mixing | | mixing | | mixing |
| | amount | ratio | amount | ratio | amount | ratio | amount | ratio | amount | ratio |
| | (g) | (%) | (g) | (%) | (g) | (%) | (g) | (%) | (g) | (%) |
| dry powder of destroyed | 2 | 98.04 | 2 | 97.09 | 2 | 99.01 | 2 | 99.01 | 2 | 99.01 |
| fond of Wolffia globosa | | | | | | | | | | |
| trisodium citrate | 0.04 | 1.96 | 0.06 | 2.91 | — | — | — | — | — | — |
| calcium gluconate | — | — | — | — | 0.02 | 0.99 | — | — | — | — |
| fermented calcium lactate | — | — | — | — | — | — | 0.02 | 0.99 | — | — |
| dietary sodium chloride | — | — | — | — | — | — | — | — | 0.02 | 0.99 |

| | | | | | |
|---|---|---|---|---|---|
| sea smell | 5 | 5 | 3 | 3 | 4 |
| flavor of material | no change | somewhat different | no change | no change | somewhat different |

### INDUSTRIAL APPLICABILITY

A destroyed frond of a Lemnoideae plant with a suppressed off-flavor which is useful as a food is provided.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A composition comprising a destroyed frond of a Lemnoideae plant and an additive selected from the group consisting of an organic acid salt, an inorganic salt, a sweetener, an acidulant, and combinations thereof.

2. The composition according to claim 1, wherein said additive is an organic acid salt or an inorganic salt.

3. A method for suppressing an off-flavor, comprising blending an additive selected from the group consisting of an organic acid salt, an inorganic salt, a sweetener and an acidulant with a destroyed frond of a Lemnoideae plant.

4. The method according to claim 3, wherein said additive is an organic acid salt or an inorganic salt.
